(19) United States
(12) Patent Application Publication
(10) Pub. No.: US 2006/0066882 A1
(43) Pub. Date: Mar. 30, 2006

(54) Image forming apparatus, image forming method, and storage medium storing program

(75) Inventors: Yasuki Yamauchi, Nakai-machi (JP); Hitoshi Ogatsu, Nakai-machi (JP); Noriko Hasegawa, Ebina-shi (JP); Toshio Koriyama, Ebina-shi (JP); Toshifumi Takahira, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/076,987

(22) Filed: Mar. 11, 2005

(30) Foreign Application Priority Data
Sep. 27, 2004 (JP) 2004-279300

(51) Int. Cl. H04N 1/60

(52) U.S. Cl. 358/1.9

(57) ABSTRACT

An image forming apparatus includes a patch data generator that generates image data of a color patch using a color value substantially equivalent to the color patch as a color sample, and an image forming unit that forms a color patch on a recording medium based on the image data of the color patch generated by the patch data generator.

### BACKGROUND OF THE INVENTION

1. Field of the Invention

The present invention relates to an image forming apparatus for performing color conversion applying a profile.

2. Description of the Related Art

For example, it is known to provide a profile correction method and device of outputting a color bar having a density management patch and a profile management patch in a predetermined position of page margin of a sheet, and correcting a profile based on the result of color measurement of the outputted color bar.

However, the device operates based on the premise that a currently-applied profile is appropriate, but has no way to check whether or not the profile is appropriate. Accordingly, the degradation of color reproducibility due to abrupt change of apparatus characteristic cannot be detected.

### SUMMARY OF THE INVENTION

The present invention has been made in view of the above circumstances and provides an image forming apparatus for performing image forming processing applying an appropriate profile.

An aspect of the present invention provides an image forming apparatus including: a patch data generator that generates image data of a color patch using a color value substantially equivalent to the color patch as a color sample; and an image forming unit that forms a color patch on a recording medium based on the image data of the color patch generated by the patch data generator.

### BRIEF DESCRIPTION OF THE DRAWINGS

Embodiments of the present invention will be described in detail based on the following figures, wherein:

FIG. 1 illustrates an example of the entire configuration of an image processing system 1;

FIG. 2 is a schematic cross-sectional diagram showing the configuration of a tandem-type printer 10;

FIG. 3 is a block diagram showing the functional configuration of a print program 5 executed by an image processing apparatus 20 (FIG. 2);

FIG. 4 illustrates an example of a color patch 710 printed by the printer 10;

FIGS. 5A and 5B illustrate tables used in the print program 5, of which FIG. 5A illustrates a color value table 502 used by a patch generator 500, and FIG. 5B illustrates a target value table 532 used by a profile determinator 530 and a profile selector 550;

FIG. 6 is a flowchart showing printing processing (S10) in the image processing system 1;

FIG. 7 illustrates a history table 572; and

FIG. 8 illustrates an example of a density patch 720 printed on a recording sheet 32.

### DETAILED DESCRIPTION OF THE INVENTION

Hereinbelow, embodiments of the present invention will be described in accordance with the accompanying drawings.

First, the entire configuration of the image processing system 1 to which the present invention is applied will be described.

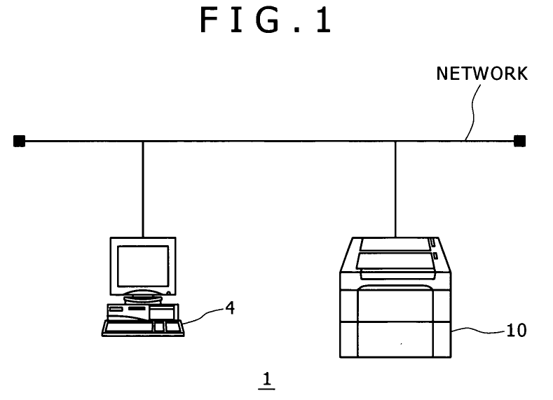

FIG. 1 illustrates an example of the entire configuration of the image processing system 1.

As shown in FIG. 1, the image processing system 1 has a client PC 4 and a tandem-type printer 10. The client PC 4 and the printer 10 are interconnected via a network such as a LAN or a WAN.

The client PC 4 is a general-purpose computer utilized by a user for image processing or the like. The client PC 4 generates image data (image data of a user-requested image) in correspondence with the user's operation, and transmits the generated user-requested image data, with a request for print processing, to the printer 10.

Next, the printer 10 to which the present invention is applied will be described.

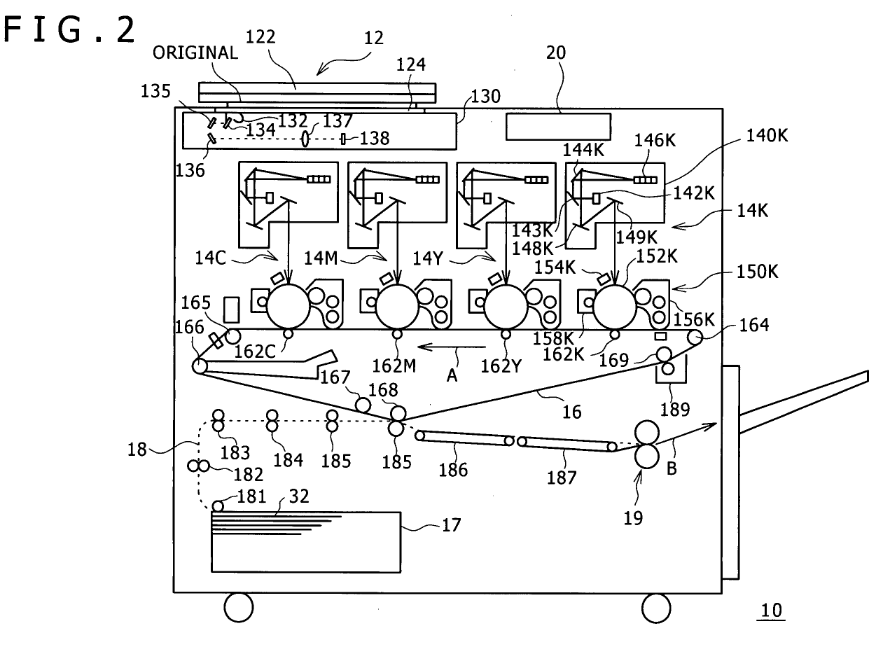

FIG. 2 is a schematic cross-sectional diagram showing the configuration of the tandem-type printer 10.

As shown in FIG. 2, the printer 10 has an image detecting unit 12, image forming units 14, an intermediate transfer belt 16, a paper tray 17, a paper transport passage 18, a fixing device 19 and an image processing apparatus 20. The printer 10 may be a multifunction machine having a full-color copier function using the image detecting unit 12 and a facsimile function, in addition to a printer function of printing image data received from the client PC 4 (FIG. 1).

First, the outline of the printer 10 will be described. The image detecting unit 12, which functions as image data input units, and the image processing apparatus 20 are provided in an upper part of the printer 10. The image detecting unit 12 detects an image of an original and outputs read image data to the image processing apparatus 20. The image processing apparatus 20 performs image processing such as color conversion, gradation correction and resolution correction on the image data inputted from the image detecting unit 12 or image data inputted from the client PC 4 or the like via the network such as a LAN (FIG. 1), and outputs the processed data to the image forming units 14.

The plural image forming units 14 are provided, in correspondence with colors constituting a color image, below the image detecting unit 12. In this embodiment, the image forming units, more specifically, a first image forming unit 14K, second image forming unit 14Y, third image forming unit 14M and fourth image forming unit 14C, respectively corresponding to black (K), yellow (Y), magenta (M) and cyan (C), are horizontally arrayed at fixed intervals along the intermediate transfer belt 16. The intermediate transfer belt 16 rotates in an arrow A direction in the figure as an intermediate transfer medium. The four image forming units 14K, 14Y, 14M and 14C sequentially form toner images in the respective colors based on image data inputted from the image processing apparatus 20, and transfer the plural toner images at a predetermined timing to superpose them, onto the intermediate transfer belt 16 (primary transfer). The order of the respective image forming units 14K, 14Y, 14M and 14C is not limited to the above black (K), yellow (Y), magenta (M) and cyan (C), but any other order, e.g., yellow (Y), magenta (M), cyan (C) and black (K) may be set arbitrarily.

The paper transport passage 18 is provided below the intermediate transfer belt 16. A recording sheet 32, supplied from the paper tray 17, is transported on the paper transport passage 18. The respective color toner images superposed on the intermediate transfer belt 16 are transferred at once onto the recording sheet 32 (secondary transfer), then the transferred toner images are fixed by the fixing device 19, and the recording sheet 32 is outputted along an arrow B to the outside.

Next, each unit of the printer 10 will be described in more detail.

As shown in FIG. 2, the image detecting unit 12 has a platen glass 124 on which the original is placed, a platen cover 122 to press the original against the platen glass 124, and an image detector 130 which detects an image of the original placed on the platen glass 124. The image detector 130 irradiates the original placed on the platen glass 124 with a light source 132, then scan-exposes an image detecting device 138 such as a CCD with a reflected light image from the original via a reduction optical system having a full rate mirror 134, a first half rate mirror 135, a second half rate mirror 136 and an image formation lens 137, and detects the color-material reflected light image of the original by the image detecting device 138 in a predetermined dot density (e.g., 16 dots/mm).

The image processing apparatus 20 performs predetermined image processing, including shading correction; original displacement correction, brightness/color space conversion, gamma correction, frame erasing, color/movement editing and the like, on image data read by the image detecting unit 12. The original color-material reflected light image detected by the image detecting unit 12 is, e.g., 3-color (red (R), green (G) and blue (B) (of 8 bits each)) original reflectance data. The data is converted by the image processing apparatus 20 into 4-color (yellow (Y), magenta (M), cyan (C) and black (K) (of 8 bits each)) original color-material gradation data.

The first image forming unit 14K, the second image forming unit 14Y, the third image forming unit 14M and the fourth image forming unit 14C (image forming unit) are arrayed in parallel at fixed intervals in a horizontal direction. The image forming units have substantially the same configuration except that colors constituting an image are different. Hereinbelow, the first image forming unit 14K will be described. The image forming units 14 in the figure are distinguished by adding alphabets K, Y, M and C.

The image forming unit 14K has an optical scanner 140K which emits a laser beam in accordance with image data inputted from the image processing apparatus 20 and an image forming device 150K which forms an electrostatic latent image with the laser beam emitted by the optical scanner 140K.

The optical scanner 140K modulates a semiconductor laser 142K in correspondence with black (K) image data, and emits a laser beam LB(K) from the semiconductor laser 142K. The laser beam LB(K) emitted from the semiconductor laser 142K is applied on a polygonal rotating mirror 146K via a first reflecting mirror 143K and a second reflecting mirror 144K, then polarized by the polygonal rotating mirror 146K, and applied on a photoconductor drum 152K of the image forming device 150K via the second reflecting mirror 144K, a third reflecting mirror 148K and a fourth reflecting mirror 149K.

The image forming device 150K has the photoconductor drum 152K as an image carrier which rotates at a predetermined rotation speed along the arrow A direction, a scorotron charger 154K for primary charging as a charging unit that uniformly charges the surface of the photoconductor drum 152K, a developing unit 156K which develops an electrostatic latent image formed on the photoconductor drum 152K, and a cleaner 158K. The photoconductor drum 152K is uniformly charged by the scorotron charger 154K, and an electrostatic latent image is formed on the drum surface with the laser beam LB(K) emitted from the optical scanner 140K. The electrostatic latent image formed on the photoconductor drum 152K is developed with black (K) toner by the developing unit 156K and transferred onto the intermediate transfer belt 16. Residual toner, paper powder and the like, attached to the photoconductor drum 152K after the process of toner image transfer, are removed by the cleaner 158K.

Similarly, the other image forming units 14Y, 14M and 14C form toner images in yellow (Y), magenta (M) and cyan (C), and transfer the color toner images onto the intermediate transfer belt 16.

The intermediate transfer belt 16 is placed around a drive roller 164, a first idle roller 165, a steering roller 166, a second idle roller 167, a backup roller 168 and a third idle roller 169, under predetermined tension. The intermediate transfer belt 16 is circulate-driven at a predetermined speed in the arrow A direction by rotation drive of the drive roller 164 by a driving motor (not shown). The intermediate transfer belt 16 is an endless-shaped belt formed with a flexible synthetic resin film of polyimide or the like shaped in a belt, both ends of which are connected by welding or the like.

Further, the intermediate transfer belt 16 has a first primary transfer roller 162K, a second primary transfer roller 162Y, a third primary transfer roller 162M and a fourth primary transfer roller 162C in positions respectively corresponding to the image forming units 14K, 14Y, 14M and 14C. The respective color toner images formed on the photoconductor drums 152K, 152Y, 152M and 152C are superposingly-transferred onto the intermediate transfer belt 16 by these primary transfer rollers 162. Residual toner attached to the intermediate transfer belt 16 is removed by a cleaning blade or a brush of a belt cleaner 189 provided downstream of the secondary transfer position.

A paper feed roller 181 to pick up the recording sheet 32 from the paper tray 17, a pair of first rollers 181, a pair of second rollers 183 and a pair of third rollers 184, respectively for paper transport, and a registration roller 185 to transport the recording sheet 32 to the secondary transfer position at predetermined timing, are provided in the paper transport passage 18.

Further, a secondary transfer roller 185, in press-contact with the backup roller 168, is provided in the secondary transfer position on the paper transport passage 18. The plural color toner images superposingly-transferred on the intermediate transfer belt 16 are secondary-transferred onto the recording sheet 32 by press-contact force of the secondary transfer roller 185 and electrostatic force. The recording sheet 32, on which the color toner images are transferred, is transported by a first transport belt 186 and a second transport belt 187 to the fixing device 19.

The fixing device 19 performs heating processing and pressurization processing on the recording sheet 32 carrying the transferred color toner images, thereby fuses and fixes the toner to the recording sheet 32.

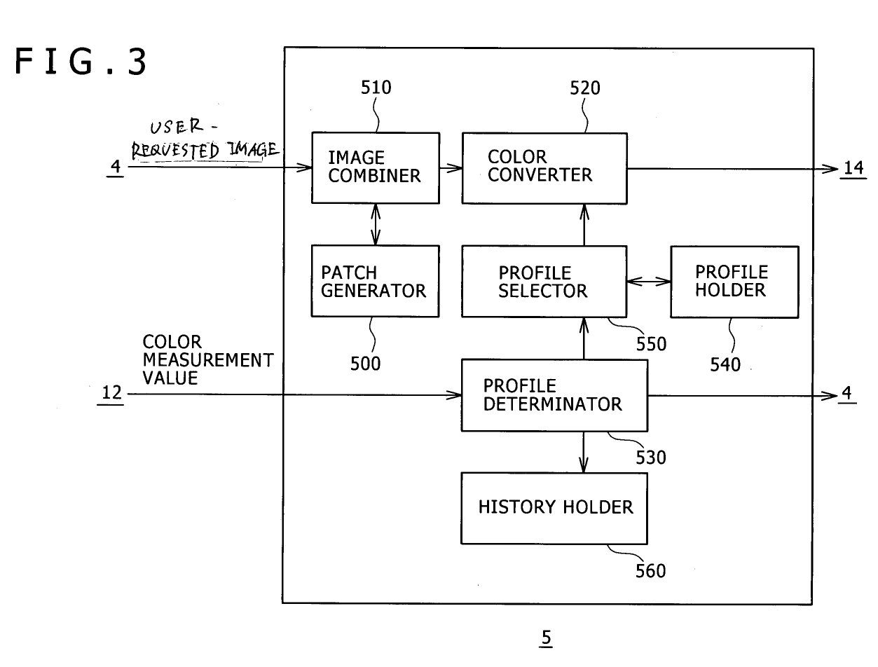

FIG. 3 is a block diagram showing the functional configuration of a print program 5 executed by an image processing apparatus 20 (FIG. 2).

As shown in FIG. 3, the print program 5 has a patch generator 500, an image combiner 510, a color converter 520, a profile determinator 530, a profile holder 540, a profile selector 550 and a history holder 560.

The print program 5 of this embodiment is software installed in the image processing apparatus 20, however, some or all the functions of the print program 5 may be implemented as hardware such as ASIC. Further, some of the functions of the print program 5 may be implemented on a driver for the client PC 4.

In the print program 5, the patch generator 500 generates color patch data using predetermined color values, and outputs the generated color patch data to the image combiner 510. For example, the patch generator 500 generates color patch data using color values (Lab values in this embodiment) substantially equivalent to a previously-printed color patch as a color sample.

The image combiner 510 generates image data of a combined image where a user-requested image and the color patch are combined, based on the user-requested image data inputted from the client PC 4 (FIG. 1) and the color patch data inputted from the patch generator 500. The image combiner 510 outputs the generated combined image data to the color converter 520.

The color converter 520 converts the combined image data (Lab color-space image data in this embodiment), inputted from the image combiner 510, into image data in color space appropriate to the color reproducibility by the printer 10 (CMYK color-space image data in this embodiment), applying the profile selected by a profile selector 550, and outputs the data to the respective image forming units 14. That is, the color converter 520 performs color conversion, applying one selected profile, on the combined image including the user-requested image and the color patch. The user-requested image and the color patch are color-converted based on the same profile. The profile, which indicates the output characteristic of the image, is, e.g., an ICC profile.

The profile determinator 530 extracts color measurement values of the color patch from an original image detected by the image detecting unit 12, then compares the extracted color-patch color measurement values with target values, and determines whether or not an appropriate profile is applied. The profile determinator 530 of this embodiment holds color-patch target color measurement values (e.g., color measurement values (Lab values) of a color sample). The profile determinator 530 calculates a difference evaluation value between the inputted color-patch color measurement values and the target color measurement values (e.g., at least one of mean color difference and maximum color difference), and determines whether or not the calculated difference evaluation value (mean color difference and/or maximum color difference) is within a predetermined allowable range. If the calculated difference evaluation value is within the predetermined allowable range, the profile determinator 530 determines that an appropriate profile is applied, and outputs the result of determination to the profile selector 550. On the other hand, if the calculated difference evaluation value is out of the predetermined allowable range, the profile determinator 530 determines that an appropriate profile is not applied, and outputs the result of determination to the profile selector 550.

Further, when the profile determinator 530 has determined that an appropriate profile is not applied, the profile determinator 530 transmits warning information, indicating that an inappropriate profile is applied, to the client PC 4. The client PC 4 receives the warning information via electronic mail or the like and displays the information.

The profile holder 540 holds plural profiles applicable to the printer 10.

When color-patch color measurement values have been inputted from the profile determinator 530 (i.e., when it has been determined that an appropriate profile is not applied), the profile selector 550 selects one of the plural profiles stored in the profile holder 540 based on the inputted color measurement values, and outputs the selected profile to the color converter 520. That is, the profile selector 550 selects a profile to be applied based on the inputted color measurement values, and replaces the profile used by the color converter 520 with the selected profile.

For example, the profile selector 550 calculates difference evaluation values between the inputted color measurement values of color patch and target color measurement values corresponding to plural profiles, and selects a profile with the minimum difference evaluation value.

The history holder 560 holds the result of determination by the profile determinator 530, the difference evaluation value calculated by the profile determinator 530, the date and time of printing of the color patch, profile identification information of the applied profile, and the like, as history data.

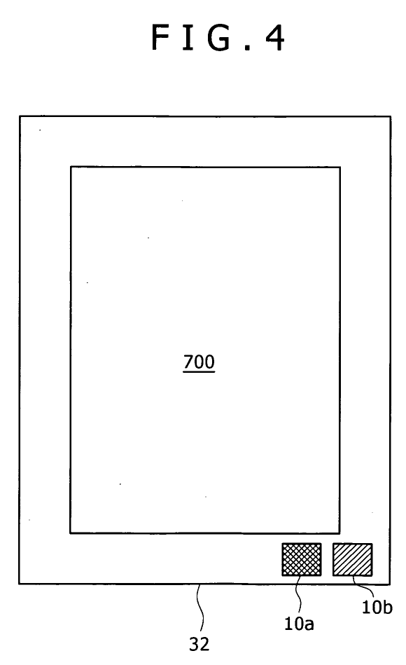

FIG. 4 illustrates an example of color patch 710 printed by the printer 10.

As shown in FIG. 4, the printer 10 prints a user-requested image 700 and the color patch 710 on the same recording sheet 32. That is, the image combiner 510 (FIG. 3) arranges the color patch 710 in a page margin area where no image component of the user-requested image 700 exists.

In this embodiment, plural color patches 710 are printed in the page margin area. The first color patch 710a and the second color patch 710b are images printed based on different color values (Lab values).

The user compares the color patches 710 printed simultaneously with the user-requested image 700 with a previously-printed color sample, thereby determines whether or not the user-requested image 700 has been printed with an appropriate profile.

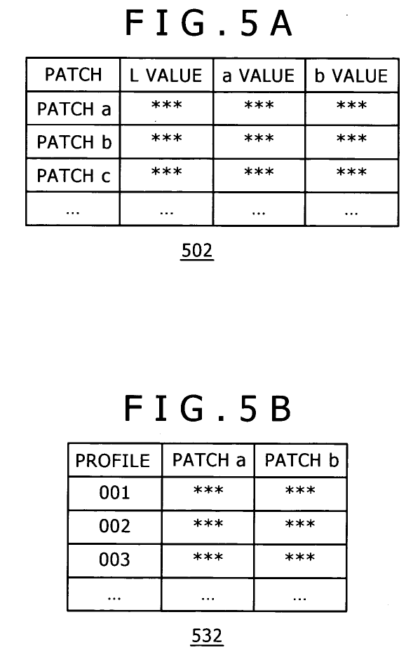

FIGS. 5A and 5B show tables used by the print program 5. FIG. 5A illustrates a color value table 502 used by the patch generator 500. FIG. 5B illustrates a target value table 532 used by the profile determinator 530 and the profile selector 550.

As shown in FIG. 5A, the patch generator 500 has the color value table 502 where patch identification information for identification of color patches (color samples) and color values (Lab values) of the color patches are associated with each other. The patch generator 500 selects color values (Lab values) corresponding to a color patch, and outputs the selected color values (Lab values) to the image combiner 510.

As shown in FIG. 5B, the profile determinator 530 has a target value table 532 where profile identification information for identification of profiles and target color measurement values (color measurement values of color samples printed by applying the respective profiles) corresponding to the profiles are associated with each other. The profile determinator 530 reads target color measurement values from the target value table 532 based on the profile identification information of the applied profile.

Further, the profile selector 550 calculates plural difference evaluation values based on the plural target color measurement values registered in the target value table 532 and the color measurement values of inputted color patches, and selects a profile with the minimum difference evaluation value.

Next, the operation of the print program 5 will be described.

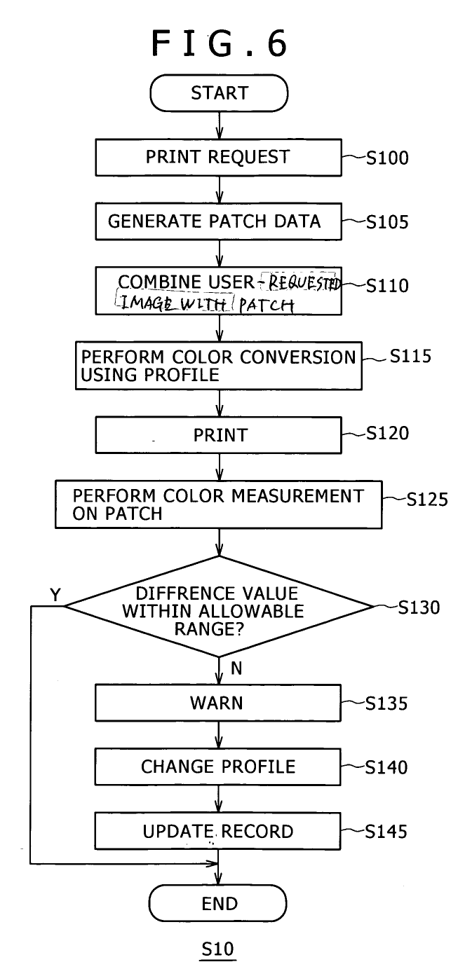

FIG. 6 is a flowchart showing printing processing (S10) in the image processing system 1.

As shown in FIG. 6, at step S100, the client PC 4 (FIG. 1) transmits print request data including user-requested image data to the printer 10 (print program 5) in accordance with the user's operation.

When the print request data has been inputted, the image combiner 510 (FIG. 3) requests color patch data from the patch generator 500. The print program 5 of this embodiment prints a color patch upon reception of each print job, however, the timing of color patch printing is not limited to the above timing, but a color patch may be printed per predetermined time period, per predetermined number of print pages, or upon every printing operation on the recording sheet 32.

At step S105, the patch generator 500 (FIG. 3) reads color values (Lab values) from the color value table 502 (FIG. 5A), generates image data of a rectangular image (color patch) rendered based on the read color values, and outputs the generated color patch image data to the image combiner 510.

At step S110, the image combiner 510 generates combined image data by inserting the color patch image data inputted from the patch generator 500 into a page margin area of the user-requested image data included in the print request data, and outputs the generated combined image data to the color converter 520.

At step S115, the color converter 520 converts the combined image data (Lab image) inputted from the image combiner 510, applying a profile selected by the profile selector 550, into CMYK color-space image data (CMYK image).

At step S120, the print program 5 performs appropriate screen processing or the like on the combined image data (CMYK image) color-converted by the color converter 520, and outputs plural color image data (cyan image, magenta image, yellow image and black image) to the respective image forming units 14 (FIG. 2).

The image forming units 14 form respective color toner images based on the image data inputted from the image processing apparatus 20 (print program 5), and transfer the toner images onto the recording sheet 32.

The recording sheet 32 holding the transferred toner images is subjected to fixing processing by the fixing device 19 (FIG. 2), and outputted to the outside of the printer 10.

At step S125, the user sets the outputted recording sheet 32 (where the user-requested image and the color patch are printed) on the image detecting unit 12 (FIG. 2).

The image detecting unit 12 reads the surface of the recording sheet 32 where the user-requested image and the color patch are printed, and converts RGB values (color measurement values) of the detected original image, by using the profile of the image detecting unit 12, into Lab color-space color measurement values (Lab values).

The profile determinator 530 (FIG. 3) extracts color-patch color measurement values from the original image (combined image) detected by the image detecting unit 12.

In the printer 10 of this embodiment, color measurement values of color path or the like are obtained by the image detecting unit 12, however, the present invention is not limited to this configuration. For example, the color-patch color measurement values may be obtained by a color measuring device (not shown) provided on the paper transport passage 18 (FIG. 2).

At step S130, the profile determinator 530 calculates a difference evaluation value between the target color measurement values registered in the target value table 532 (FIG. 5B) and the color-patch color measurement values extracted from the original image (combined image), and determines whether or not the calculated difference evaluation value is within a predetermined allowable range.

If the calculated difference evaluation value is within the allowable range, the print program 5 proceeds to processing at step S145, while if the calculated difference evaluation value is out of the allowable range, the print program 5 outputs the color-patch color measurement values to the profile selector 550 and proceeds to processing at step S135.

At step S135, the profile determinator 530 (FIG. 3) transmits warning information, indicating that an inappropriate profile is applied, to the client PC 4 (FIG. 1) via electronic mail.

The client PC 4 receives the warning information via electronic mail and displays the information.

At step S140, the profile selector 550 (FIG. 3) calculates difference evaluation values between the color measurement values inputted from the profile determinator 530 and target color measurement values corresponding to plural profiles (target color measurement values registered in the target value table 532). The profile selector 550 selects a profile with the minimum difference evaluation value, and replaces the profile used by the color converter 520 with the selected profile.

At step S145, the history holder 560 adds the result of determination by the profile determinator 530, the difference evaluation value calculated by the profile determinator 530, the date and time of printing of the color patch, and profile identification information of the applied profile, to the history table 572 (to be described later).

Further, when a profile has been changed, the history holder 560 stores the profile identification information of the changed profile into the history table 572.

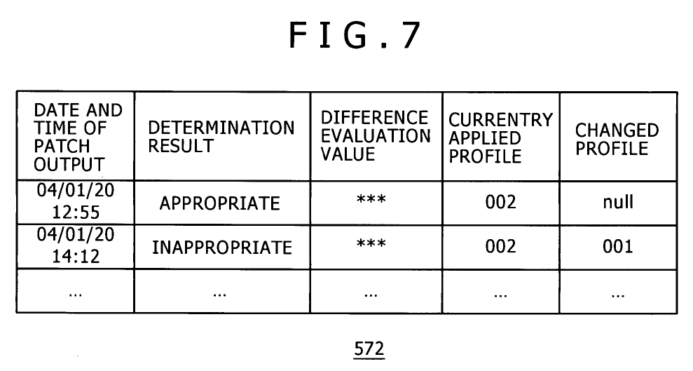

FIG. 7 illustrates the history table 572.

As shown in FIG. 7, the history table 572 holds the result of determination, the difference evaluation value and profile identification information of the applied profile associated with the date and time of printing of the color patch.

As described above, the image processing system 1 according to this embodiment prints a color patch using predetermined color values at a predetermined timing, and determines based on the color measurement values of the printed color patch whether or not the applied profile is appropriate. In this configuration, abrupt change of an apparatus characteristic, mis-selection of a profile or the like can be appropriately handled, and stable color reproducibility can be realized.

A modification to the above embodiment will be described.

The printer 10 of the above embodiment performs color measurement on a color patch by the image detecting unit 12, and changes a profile based on the result of color measurement, however, the present invention is not limited to this configuration. For example, it may be configured such that only the warning information is outputted and the profile is changed in accordance with a user's instruction.

Further, the printer 10 may print a density patch 720 for density management, in addition to the color patch 710 for color management.

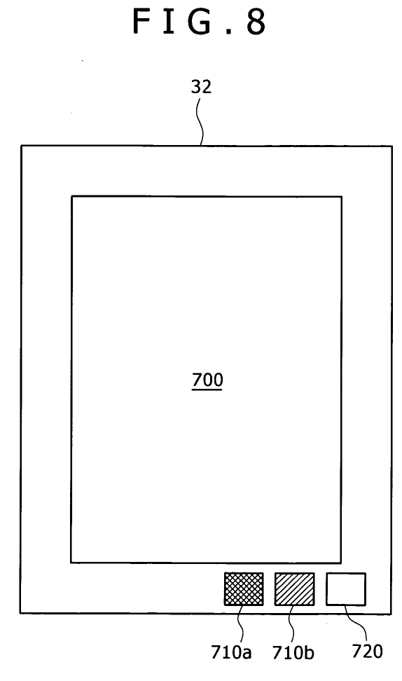

FIG. 8 illustrates an example of the density patch 720 printed on the recording sheet 32.

As shown in FIG. 8, the printer 10 according to the modification prints the color patch 710 and the density patch 720 for density management in a page margin area of the user-requested image 700.

In this configuration, the user can determine whether the profile has been mis-selected or the profile itself is to be updated (reconstructed).

As described above, an aspect of the present invention provides an image forming apparatus including: a patch data generator that generates image data of a color patch using a color value substantially equivalent to the color patch previously outputted as a color sample; and an image forming unit that forms a color patch on a recording medium based on the image data of the color patch generated by the patch data generator.

The patch data generator may generate image data, in which the color patch is arranged in a page margin area of a user-requested image, to be outputted on an output request from a user, and the image forming unit may form an image including the user-requested image and the color patch on the recording medium based on the image data generated by the patch data generator.

The image forming apparatus may further include a color converter that performs color conversion processing, applying one selected profile, on the image data generated by the patch data generator, and the image forming unit may form the user-requested image and the color patch on the recording medium based on the image data subjected to the color conversion processing by the color converter.

The image forming unit may form the color patch on the recording medium based on the image data subjected to color conversion processing applying one selected profile, and the apparatus may further include: a color measurement unit that performs color measurement on the color patch formed on the recording medium by the image forming unit; and a profile determination unit that determines based on a color measurement value of the color patch obtained by the color measurement by the color measurement unit whether or not the applied profile is appropriate.

The image forming apparatus may further include a profile change unit that changes a profile to be applied in correspondence with a result of the determination by the profile determination unit.

The profile determination unit may determine whether or not the applied profile is appropriate by comparing the color measurement value of the color patch with a predetermined target value, and the apparatus may further include a difference value storage unit that stores a difference value between the color measurement value of the color patch obtained by the color measurement by the color measurement unit and the target value.

Further, another aspect of the present invention provides an image forming apparatus including: a patch data generator that generates image data of a color patch by using a predetermined color value; and an image forming unit that forms a color patch in a page margin area of a user-requested image, to be outputted on an output request from a user, based on the image data of the color patch generated by the patch data generator.

Further aspect of the present invention provides an image forming apparatus including: an image forming unit that forms a color patch on a recording medium based on image data subjected to color conversion processing applying a predetermined profile; a color measurement unit that performs color measurement on the color patch formed on the recording medium by the image forming unit; a profile determination unit that determines based on a color measurement value of the color patch obtained by the color measurement by the color measurement unit whether or not the applied profile is appropriate; and a profile change unit that changes a profile to be applied in correspondence with a result of determination by the profile determination unit.

Further aspect of the present invention provides an image forming method including: generating image data of a color patch using a color value substantially equivalent to the color patch previously outputted as a color sample; and forming a color patch on a recording medium based on the generated image data of the color patch.

Further aspects of the present invention provides a computer storage medium readable by a computer in an image forming apparatus, the storage medium storing a program of instructions executed by the computer to perform a function including: generating image data of a color patch using a color value substantially equivalent to the color patch previously outputted as a color sample; and forming a color patch on a recording medium based on the generated image data of the color patch.

According to these aspects of the image forming apparatus of the present invention, it is possible to determine whether or not an appropriate profile is selected.

While this invention has been described in connection with certain embodiments, it is to be understood that the subject matter encompassed by way of this invention is not to be limited to those specific embodiments. On the contrary, it is intended for the subject matter of the invention to include all alternative, modification and equivalents as can be included within the spirit and scope of the following claims.

The entire disclosure of Japanese Patent Application No. 2004-279300 filed on Sep. 27, 2004 including specification, claims, drawings and abstract is incorporated herein by reference in its entirety.

What is claimed is:

1. An image forming apparatus comprising:
a patch data generator that generates image data of a color patch using a color value substantially equivalent to the color patch as a color sample; and
an image forming unit that forms a color patch on a recording medium based on the image data of the color patch generated by the patch data generator.

2. The image forming apparatus according to claim 1, wherein the patch data generator generates image data, in which the color patch is arranged in a page margin area of a user-requested image, to be outputted on an output request from a user, and
the image forming unit forms an image including the user-requested image and the color patch on the recording medium based on the image data generated by the patch data generator.

3. The image forming apparatus according to claim 2, further comprising a color converter that performs color conversion processing, applying one selected profile, on the image data generated by the patch data generator,
wherein the image forming unit forms the user-requested image and the color patch on the recording medium based on the image data subjected to the color conversion processing by the color converter.

4. The image forming apparatus according to claim 1, wherein the image forming unit forms the color patch on the recording medium based on the image data subjected to color conversion processing applying one selected profile, and the apparatus further comprising:
a color measurement unit that performs color measurement on the color patch formed on the recording medium by the image forming unit; and
a profile determination unit that determines whether or not the applied profile is appropriate based on a color measurement value of the color patch obtained by the color measurement unit.

5. The image forming apparatus according to claim 4, further comprising a profile change unit that changes a profile to be applied in correspondence with a result of the determination by the profile determination unit.

6. The image forming apparatus according to claim 4, wherein the profile determination unit determines whether or not the applied profile is appropriate by comparing the color measurement value of the color patch with a predetermined target value, and
the apparatus further comprising a difference value memory that stores a difference value between the color measurement value of the color patch obtained by the color measurement by the color measurement unit and the target value.

7. An image forming apparatus comprising:
a patch data generator that generates image data of a color patch by using a predetermined color value; and
an image forming unit that forms a color patch in a page margin area of a user-requested image, to be outputted on an output request from a user, based on the image data of the color patch generated by the patch data generator.

8. An image forming apparatus comprising:
an image forming unit that forms a color patch on a recording medium based on image data subjected to color conversion processing applying a predetermined profile;
a color measurement unit that performs color measurement on the color patch formed on the recording medium by the image forming unit;
a profile determination unit that determines whether or not the applied profile is appropriate based on a color measurement value of the color patch obtained the color measurement unit; and
a profile change unit that changes a profile to be applied, in correspondence with a result of the determination by the profile determination unit.

9. An image forming method comprising:
generating image data of a color patch using a color value substantially equivalent to the color patch previously outputted as a color sample; and
forming a color patch on a recording medium based on the generated image data of the color patch.

10. A computer storage medium readable by a computer in an image forming apparatus, the storage medium storing a program of instructions executed by the computer to perform a function comprising:
generating image data of a color patch using a color value substantially equivalent to the color patch previously outputted as a color sample; and
forming a color patch on a recording medium based on the generated image data of the color patch.
